(19) United States
(12) Patent Application Publication
(10) Pub. No.: US 2025/0391994 A1
(43) Pub. Date: Dec. 25, 2025

(54) ELECTRODE ASSEMBLIES, PREPARATION METHODS THEREOF, AND RECHARGEABLE LITHIUM BATTERIES

(71) Applicant: SAMSUNG SDI CO., LTD., Yongin-si (KR)

(72) Inventors: Moonju CHO, Yongin-si (KR); Seung-Hun HAN, Yongin-si (KR); Youngkwang CHO, Yongin-si (KR); Hyunwoo KIM, Yongin-si (KR); Seunghyun JEON, Yongin-si (KR); Seunghyun LIM, Yongin-si (KR); Beom Kwon KIM, Yongin-si (KR)

(73) Assignee: SAMSUNG SDI CO., LTD., Yongin-si (KR)

(21) Appl. No.: 19/241,994

(22) Filed: Jun. 18, 2025

(30) Foreign Application Priority Data
Jun. 25, 2024 (KR) 10-2024-0082924

(51) Int. Cl. H01M 50/383; A62D 1/06; H01M 4/02; H01M 4/62; H01M 10/052; H01M 10/613; H01M 10/658; H01M 50/119

(52) U.S. Cl. CPC H01M 50/383; A62D 1/06; H01M 4/622; H01M 10/052; H01M 10/613; H01M 10/658; H01M 50/119; H01M 2004/021; H01M 2200/10

(57) ABSTRACT

Disclosed are an electrode assembly, a manufacturing method thereof, and a rechargeable lithium battery, the electrode assembly including a unit laminate including a positive electrode and a negative electrode; an uncoated region covering at least a portion of the unit laminate; and a safety functional layer on at least a portion of the uncoated region. The safety functional layer includes an extinguishing capsule, the extinguishing capsule is a core including a substituted or unsubstituted halogen compound; and a shell surrounding the core and including a polymer compound.

### CROSS-REFERENCE TO RELATED APPLICATION

This application claims priority to Korean Patent Application No. 10-2024-0082924 filed in the Korean Intellectual Property Office on Jun. 25, 2024, the entire contents of which are incorporated herein by reference.

### BACKGROUND

### 1. Field

Electrode assemblies, preparation methods thereof, and rechargeable lithium batteries are disclosed.

### 2. Description of the Related Art

A portable information device such as, e.g., a cell phone, a laptop, smart phone, and the like, or an electric vehicle, typically uses a rechargeable lithium battery having high energy density and portability as a driving power source.

In particular, as interest in electric vehicles grows, interest in rechargeable batteries mounted in the electric vehicles is also growing, and demand for high-capacity and rapid-charging rechargeable batteries is increasing.

However, as the rechargeable batteries become larger in capacity and faster in charging speed to be used in the electric vehicles and the like, there are concerns about safety of the rechargeable batteries. In such situations, the high-capacity batteries may generate heat during the operation, causing rapid internal temperature rise, which may cause thermal runaway.

### SUMMARY

Some example embodiments include an electrode assembly and a method for preparing the electrode assembly, and a rechargeable lithium battery, and the electrode assembly is configured to secure desired or improved energy density without significantly increasing the thickness of the entire battery, while reducing or preventing explosion of the battery by reducing or suppressing direct temperature rise when an internal short circuit occurs, and improving the safety of the battery.

In some example embodiments, an electrode assembly includes a unit laminate including a positive electrode and a negative electrode; an uncoated region surrounding at least a portion of the unit laminate; and a safety functional layer on at least a portion of the uncoated region. The safety functional layer includes an extinguishing capsule. The extinguishing capsule includes a core including a substituted or unsubstituted halogen compound; and a shell surrounding the core and including a polymer compound.

In some example embodiments, a method of preparing an electrode assembly includes preparing a unit laminate including a positive electrode and a negative electrode, assembling the uncoated region to surround at least a portion of the unit laminate, and forming a safety functional layer on at least a portion of the uncoated region. The safety functional layer includes an extinguishing capsule. The extinguishing capsule is a core including a substituted or unsubstituted halogen compound; and a shell surrounding the core and including a polymer compound.

In some example embodiments, a rechargeable lithium battery includes the aforementioned electrode assembly; and a battery case accommodating the electrode assembly.

According to some example embodiments, an electrode assembly, a method for preparing the electrode assembly, and a rechargeable lithium battery, are configured to secure desired or improved energy density without significantly increasing the thickness of the entire battery, while reducing or preventing explosion of the battery by reducing or suppressing direct temperature rise when an internal short circuit occurs, and improving the safety of the battery.

### BRIEF DESCRIPTION OF THE DRAWINGS

FIGS. 1 to 4 are perspective views schematically showing rechargeable lithium batteries according to some example embodiments.

FIG. 5 is a perspective view schematically illustrating an electrode assembly according to some example embodiments.

FIGS. 6 to 12 are cross-sectional views schematically showing an electrode assembly according to some example embodiments.

FIG. 13 is a perspective view schematically illustrating a preparing process of an electrode assembly according to some example embodiments.

FIG. 14 shows the results of a penetration evaluation of a needle conductor performed on a rechargeable lithium battery cell prepared in Example 1.

FIG. 15 shows the results of evaluating the penetration of a needle conductor on a rechargeable lithium battery cell prepared in Comparative Example 1.

FIG. 16 shows the results of evaluating the penetration of a needle conductor on a rechargeable lithium battery cell prepared in Comparative Example 2.

FIG. 17 is a flow chart illustrating a method for preparing an electrode assembly, according to an example embodiment.

### DETAILED DESCRIPTION

Hereinafter, example embodiments are described in detail so that those of ordinary skill in the art can readily implement the example embodiments. However, this disclosure may be embodied in many different forms and is not construed as limited to the example embodiments set forth herein.

The terminology used herein is used to describe example embodiments only, and is not intended to limit the present disclosure. The singular expression includes the plural expression unless the context clearly dictates otherwise.

As used herein, “combination thereof” indicates a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, and the like, are exaggerated for clarity, and like reference numerals designate like elements throughout the specification. It is understood that when an element such as a layer, film, region, or substrate is referred to as being “on” another element, the element can be directly on the other element, or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

The average particle diameter may be measured by a method well known to those skilled in the art, for example, by, e.g., a particle size analyzer, or by a transmission electron microscope image or a scanning electron microscope image. Alternatively, it is possible to obtain an average particle diameter value by measuring using a dynamic light scattering method, performing data analysis, counting the number of particles for each particle size range, and calculating from this method. Unless otherwise defined, the average particle diameter may indicate the diameter (D₅₀) of particles having a cumulative volume of 50 volume % in the particle size distribution. As used herein, when a definition is not otherwise provided, the average particle diameter indicates a diameter (D₅₀) of particles having a cumulative volume of 50 volume % in the particle size distribution that is obtained by measuring the size (diameter or major axis length) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

Herein, “substituted” refers to replacement of at least one hydrogen by a substituent such as or including at least one of a halogen element, a hydroxy group, a C1 to C20 alkoxy group, a nitro group, a cyano group, amine group, an imino group, an azido group, an amidino group, a hydrazino group, a hydrazono group, a carbonyl group, a carbamyl group, a thiol group, an ester group, ether group, a carboxyl group or a salt thereof, a sulfonic acid group or a salt thereof, a phosphoric acid group or a salt thereof, a C1 to C20 alkyl group, a C2 to C20 alkenyl group, a C2 to C20 alkynyl group, a C6 to C20 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, or a combination thereof.

For example, “substituted” may indicate that at least one hydrogen is substituted with a substituent such as or including at least one of a hydroxy group, a C1 to C10 alkoxy group, a C1 to C10 alkyl group, a C2 to C10 alkenyl group, a C2 to C10 alkynyl group, a C6 to C20 aryl group, a C3 to C10 cycloalkyl group, or a combination thereof.

For example, “substituted” may indicate that at least one hydrogen is substituted with a substituent such as or including at least one of a hydroxy group, a C1 to C5 alkoxy group, a C1 to C10 alkyl group, a C2 to C10 alkenyl group, a C2 to C10 alkynyl group, a C6 to C20 aryl group, a C3 to C10 cycloalkyl group, or a combination thereof.

When the terms “about” or “substantially” are used in this specification in connection with a numerical value, it is intended that the associated numerical value include a tolerance of +10% around the stated numerical value. When ranges are specified, the range includes all values therebetween such as increments of 0.1%.

### Electrode Assembly

In some example embodiments, an electrode assembly includes a unit laminate including a positive electrode and a negative electrode; an uncoated region surrounding at least a portion of the unit laminate; and a safety functional layer on at least a portion of the uncoated region. The safety functional layer includes an extinguishing capsule, and the extinguishing capsule includes a core including a substituted or unsubstituted halogen compound; and a shell surrounding the core and including a polymer compound.

In response to a demand for improving capacity and a charging speed of rechargeable batteries for use in, e.g., electric vehicles and the like, securing safety of the rechargeable batteries that satisfy these performance requirements may present a challenge. In such situations, the high-capacity batteries may generate heat during the operation, causing a rapid internal temperature rise, which may cause thermal runaway. This thermal runaway phenomenon may be caused by internal short circuits of the rechargeable batteries, particularly by direct impacts with a sharp needle conductor penetrating internal electrode plates of the batteries. Herein, electrical energy stored in each electrode of the short-circuited positive and negative electrodes may become instantly discharged, which may increase a risk of explosion of the battery.

Accordingly, some example embodiments include an electrode assembly capable of reducing or preventing battery explosion, and improving battery safety by reducing or suppressing temperature rise, when internal short circuits occur.

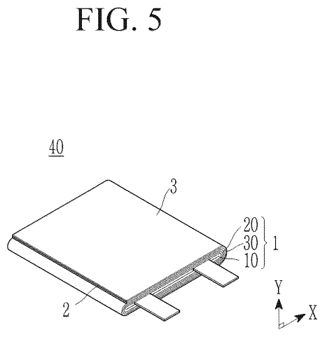

FIG. 5 show a schematic perspective view of an electrode assembly 40, according to some example embodiments. Referring to FIG. 5, the electrode assembly 40 according to some example embodiments includes a unit laminate 1 including a positive electrode 10 and a negative electrode 20; an uncoated region 2 covering at least a portion of the unit laminate; and a safety functional layer 3 on at least a portion of the uncoated region, wherein the safety functional layer 3 includes an extinguishing capsule to secure battery safety. Accordingly, the formation of the safety functional layer including the extinguishing capsule having direct insulation and cooling effects on the uncoated region wrapping at least a portion of the unit laminate may improve battery safety as well as secure high energy density by substantially increasing an entire thickness of a battery.

In order to secure the battery safety, rather than the method of directly forming the safety functional layer on at least a portion of the uncoated region, there may be another method of forming the safety functional layer, or an insulation layer, on an interior wall of a battery case or on the inner surface of a case film before molding the case film into the battery case, which is in contact with at least a portion of the unit laminate.

However, the method of forming the safety functional layer or the insulation layer on the inner wall of the battery case, may not only present a challenge in forming the safety functional layer or the insulation layer to have a substantially uniform thickness because the inner wall of the battery case is curved, but also the safety functional layer or the insulation layer formed on the inner wall of the battery case may be damaged or deformed in a subsequent sealing process after housing the unit laminate into the battery case.

In addition, even in the method of forming the safety functional layer or the insulation layer on the inner wall of the case film before molding the case film into the battery case, which is in contact with at least a portion of the unit laminate, the safety functional layer or the insulation layer may be damaged or deformed in the molding process of the case film to the battery case, or during the sealing process after housing the unit laminate in the battery case.

Accordingly, as for these methods, in which the safety functional layer desired to be expressed at a high temperature is damaged or deformed in the molding process of the battery case or the sealing process after housing the unit laminate into the battery case, the safety functional layer may hardly be expressed at the high temperature.

Accordingly, some example embodiments include directly forming the safety functional layer on at least a portion of the uncoated region to reduce or prevent damage of the safety functional layer in the subsequent processes and secure safety. In addition, when the safety functional layer on at least a portion of the uncoated region is formed, because the uncoated region, a substrate, is rolled together with the safety functional layer in a penetration evaluation by a needle conductor, the direct formation of the safety functional layer on at least a portion of the uncoated region may have the desired or improved effect of securing safety even in the penetration evaluation by a needle conductor.

For example, the extinguishing capsule includes a core including a substituted or unsubstituted halogen compound; and a shell surrounding the core and including a polymer compound. The extinguishing capsule having a core-shell structure may be included to express an effect of an extinguishing agent by a substituted or unsubstituted halogen compound, which is included in the core, as the polymer compound included in the shell ruptures, when a battery temperature rises, thereby securing or improving battery safety. In particular, when internal short circuits of electrode plates occur due to penetration of rechargeable batteries by, e.g., a needle conductor, increasing an internal temperature rapidly, the safety functional layer of the electrode plates may reduce or suppress such a thermal runaway, thereby reducing or preventing explosion of the batteries.

In the extinguishing capsule, the core includes a substituted or unsubstituted halogen compound. The halogen compound includes a halogen element, and the halogen element may include at least one of F, C1, Br, I, or a combination thereof, or at least one of F, C1, Br, or a combination thereof. The extinguishing capsule includes the substituted or unsubstituted halogen compound in the core to reduce or prevent internal short circuits due to penetration of a needle conductor, and directly reduce or suppress thermal runaway due to the desired or improved effect of reducing overall battery temperatures.

In some example embodiments, the substituted or unsubstituted halogen compound may include at least one of a substituted or unsubstituted halogenated alkyl, a substituted or unsubstituted halogenated alkene, a substituted or unsubstituted halogenated alkyne, a substituted or unsubstituted halogenated cycloalkyl, a substituted or unsubstituted halogenated acyl, a substituted or unsubstituted halogenated ketone, or a combination thereof. When the substituted or unsubstituted halogen compound includes the above compounds, the effect of internal short-circuit reduction or suppression and extinguishing effect can be effectively exerted when penetrating the needle conductor, thereby reducing or preventing ignition of the battery.

For example, the carbon number of the substituted or unsubstituted halogen compound may be C1 to C10, for example, C1 to C9, C2 to C8, or C3 to C7. For example, the halogen compound may include a substituted or unsubstituted C1 to C10 halogenated alkyl, a substituted or unsubstituted C2 to C6 halogenated alkene, a substituted or unsubstituted C2 to C6 halogenated alkyne, a substituted or unsubstituted C3 to C6 halogenated cycloalkyl, a substituted or unsubstituted C1 to C10 halogenated acyl, a substituted or unsubstituted C1 to C10 halogenated ketone, or a combination thereof.

For example, the substituted or unsubstituted halogen compound may include a substituted or unsubstituted C3 to C7 halogenated alkyl, a substituted or unsubstituted C3 to C7 halogenated acyl, a substituted or unsubstituted C3 to C7 halogenated ketone, or a combination thereof. When the substituted or unsubstituted halogen compound includes the above compounds, it may be possible to secure the insulating effect when the needle conductor penetrates, and it may be possible to secure the cooling and extinguishing effects when the temperature rises abnormally.

For example, the halogen compound refers to a compound in which at least one hydrogen is replaced by a halogen element. At this time, in addition to being substituted with the above-mentioned halogen element, the halogen compound may also have at least one hydrogen substituted or unsubstituted with a substituent. For example, the halogen compound may be a halogen compound having at least one hydrogen such as or including at least one of a hydroxy group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid group or a salt thereof, a C1 to C20 alkyl group, a C2 to C20 alkenyl group, a C2 to C20 alkynyl group, a C6 to C20 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, or a combination thereof.

For example, the halogen compound may have at least one hydrogen substituted with a substituent such as or including at least one of a hydroxy group, a C1 to C10 alkoxy group, a C1 to C10 alkyl group, a C2 to C10 alkenyl group, a C2 to C10 alkynyl group, a C6 to C20 aryl group, a C3 to C10 cycloalkyl group, or a combination thereof.

As an example of the halogenated alkyl, in the case of fluoromethane, the halogenated alkyl may include at least one hydrogen in methane being replaced by a halogen element F, and the number of halogen elements F is sufficient as long as the number of halogen elements F is equal to 1 or more, and the upper limit of the number is not particularly limited. For example, fluoromethane may include at least one of monofluoromethane, difluoromethane, trifluoromethane, tetrafluoromethane, and the like. Accordingly, the halogenated alkyl may include at least one of chloromethane, bromomethane, fluoroethane, chloroethane, bromoethane, fluoropropane, chloropropane, bromopropane, fluorobutane, chlorobutane, bromobutane, and the like. Similarly, fluorochloromethane may indicate methane in which at least one hydrogen is replaced by F, and at least one other hydrogen is replaced by Cl, and may include, for example, at least one of difluorodichloromethane, trifluorochloromethane, fluorotrichloromethane, and the like.

For example, the halogen compound may include 1 to 15, for example 2 to 14, 5 to 13, or 10 to 13 halogen elements within the compound. In this range, the halogen compound can be more desirable to secure the insulation effect when the needle conductor penetrates, and the cooling and extinguishing effects when the temperature rises abnormally.

For example, the substituted or unsubstituted halogen compound may include at least one of monofluoromethane, difluoromethane, trifluoromethane, tetrafluoromethane, trifluorobromomethane, difluorochloromethane, trifluoroiodomethane, pentafluoroethane, pentachloroethane, pentabromoethane, tetrafluorodibromoethane, difluorochlorobromoethane, octafluorodichloroethane, chlorotetrafluoroethane, heptafluoropropane, heptachloropropane, heptabromopropane, hexafluoropropane, hexachloropropane, hexabromopropane, decafluorobutane, dodecafluoro-2-methylpentan-3-one, decafluoromethoxytrifluoromethylpentane, or a combination thereof. When the above is satisfied, the insulation effect when penetrating the needle conductor and the cooling and extinguishing effect when the temperature rises abnormally can be further improved.

As an example, the substituted or unsubstituted halogen compound may be or include 1,1,1,2,2,3,4,5,5,5-decafluoro-3-methoxy-4-(trifluoromethyl)-pentane. When the above is satisfied, the insulation effect when penetrating the needle conductor and the cooling and extinguishing effect when the temperature rises abnormally can be improved or maximized.

For example, the boiling point of the substituted or unsubstituted halogen compound may be greater than or equal to about 90° C., for example, the boiling point may be in a range of about 100° C. to about 160° C., about 100° C. to about 155° C., or about 100° C. to 150 about ° C. By using a halogen compound having such a boiling point range as a substance included in the core of the extinguishing capsule, the shell of the extinguishing capsule can be ruptured by volume expansion due to the vaporization process of the substance included in the core when the battery rises to an abnormal temperature that is greater than or equal to about 90° C., thereby releasing the substance included in the core, allowing the halogen compound, which is an extinguishing agent, to take effect.

For example, the halogen compound may be included in an amount in a range of about 10 wt % to about 90 wt %, for example, about 25 wt % to about 75 wt %, about 35 wt % to about 65 wt %, or about 45 wt % to about 55 wt %, based on 100 wt % of the extinguishing capsule. In the above range, the effect of ensuring battery safety through reduction or suppression of ignition when the needle conductor penetrates or when the temperature rises abnormally due to inclusion of a halogen compound as a core can be improved or maximized.

The extinguishing capsule includes a shell surrounding the core, and the shell may be formed with a substantially uniform thickness on the core, or may be formed with an uneven thickness.

In the extinguishing capsule, the shell includes a polymer compound. The shell is configured to safely protect the halogen compound, which is a substance included in the core, under normal circumstances. Therefore, by including a polymer compound in the shell, the effect of the extinguishing agent, which is a material of the core, can be exhibited only when the needle conductor penetrates, or when the temperature rises abnormally.

For example, the polymer compound may include an acrylate-based resin, for example at least one of polymethyl acrylate, polymethyl methacrylate, polyethyl acrylate, polyethyl methacrylate, poly(n-propyl acrylate), poly(n-propyl methacrylate), polyisopropyl acrylate, polyisopropyl methacrylate, polybutyl acrylate, polybutyl methacrylate, polyisobutyl acrylate, polyisobutyl methacrylate, polyethylhexyl acrylate, polyethylhexyl methacrylate, or a combination thereof. When the above is satisfied, the battery performance is not impaired by causing side reactions with the electrolyte solution, and the like, which are components of the battery in normal times, and the shell is effectively ruptured only by the volume expansion of the core when the needle conductor penetrates or the temperature rises abnormally, thereby efficiently securing or improving the safety of the battery.

For example, the weight average molecular weight (Mw) of the polymer compound may be in a range of about 200,000 g/mol to about 400,000 g/mol, for example about 250,000 g/mol to about 350,000 g/mol, or about 300,000 g/mol to about 350,000 g/mol. When the above is satisfied, the shell can be effectively ruptured by the volume expansion of the core when the needle conductor penetrates, or when the temperature rises to an abnormal temperature of greater than or equal to about 90° C., which can be desirable for the extinguishing agent, which is the core material, to be effective.

The polymer compound may be included in an amount in a range of about 10 wt % to about 90 wt %, for example, about 25 wt % to about 75 wt %, about 35 wt % to about 65 wt %, or about 45 wt % to about 55 wt %, based on 100 wt % of the extinguishing capsule. In the above range, desired or improved charge/discharge efficiency can be secured without impairing the battery's performance under normal conditions.

In some example embodiments, the average particle diameter (D₅₀) of the extinguishing capsule may be in a range of about 0.1 μm to about 3 μm, for example about 0.2 μm to about 2 μm, or about 0.3 μm to about 1 μm. When the above is satisfied, the effects of ensuring desired or improved safety and improving energy density can be harmonized.

For example, in the extinguishing capsule, an average diameter of the core may be in a range of about 0.1 μm to about 2 μm, for example about 0.15 μm to about 1.5 μm, or about 0.25 μm to about 1.25 μm. When the above is satisfied, the effect of direct temperature rise reduction or suppression when an internal short circuit occurs can be improved or maximized, effectively reducing or preventing battery explosion, and helping to secure or improve battery safety.

For example, in the extinguishing capsule, a thickness of the shell may be in a range of about 0.001 μm to about 0.05 μm, for example about 0.005 μm to about 0.05 μm, or about 0.01 μm to about 0.05 μm. When the above is satisfied, the safety of the battery can be effectively secured when the needle conductor penetrates, or when the temperature rises abnormally, without impairing the performance of the battery under normal conditions.

For example, the safety functional layer may further include a binder, and the binder may include styrene butadiene rubber. When the above is satisfied, the safety of the battery can be effectively secured or improved when the needle conductor penetrates, or when the temperature rises abnormally, without impairing the performance of the battery under normal conditions.

For example, the thickness of the safety functional layer may be in a range of about 10 μm to about 50 μm, for example about 13 μm to about 45 μm, about 15 μm to about 40 μm, or about 20 μm to about 35 μm. In the above range, the effects of ensuring desired or improved safety and improving energy density can be harmoniously achieved.

In some example embodiments, the uncoated region may be or include a portion of a positive electrode substrate (positive electrode current collector) where a positive electrode active material layer is not formed. Accordingly, one surface 104 of the positive electrode substrate opposite to the other surface on which the positive electrode active material layer is coated is a portion where the positive electrode active material layer is not formed, which may be an uncoated region.

For example, the uncoated region may be or include at least one of an aluminum substrate, a stainless steel (SUS) substrate, or a combination thereof.

For example, the safety functional layer may be disposed on at least a portion between the unit laminate and the uncoated region, or at least a portion of the outermost surface of the uncoated region.

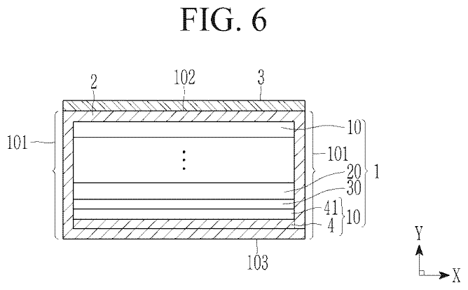

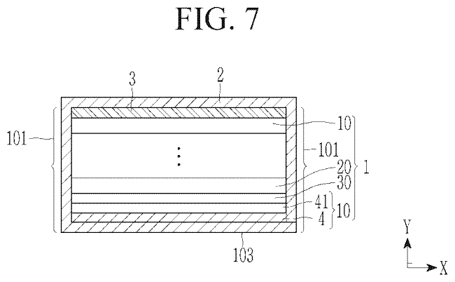

FIGS. 6 and 7 show a cross-sectional view of the electrode assembly 40 of FIG. 5 in the X-Y plane to illustrate the location of the safety functional layer 3.

In some example embodiments, the uncoated region 2 may include at least one of a side portion 101 wrapping both sides of the unit laminate 1; an upper portion 102 wrapping an upper electrode in a stacking direction (Y) of the unit laminate 1; and a lower portion 103 wrapping a lower electrode of the unit laminate 1 in the stacking direction (Y). For example, at least either one of the upper electrode and the lower electrode may be or include the positive electrode 10, or both the upper electrode and the lower electrode may be the positive electrode 10. Herein, the upper electrode may be an electrode located at the outermost of the upper portion in the stacking direction (Y), and the lower electrode may be an electrode located at the outermost of the lower portion in the stacking direction (Y).

In some example embodiments, the safety functional layer 3, as shown in FIG. 6, may be disposed on at least one outermost surface of the side portion 101, the upper portion 102, and the lower portion 103, and/or the safety functional layer 3, as shown in FIG. 7, may be disposed between at least one of the side portion 101, the upper portion 102, and the lower portion 103 and the unit laminate 1. Accordingly, when the safety functional layer is formed on a portion of the surface of the uncoated region, compared to a conventional art of having an insulation layer to secure safety, may be advantageous in securing desired or improved energy density by effectively reducing the entire thickness of batteries.

For example, the safety functional layer 3 may be disposed on at least one outermost surface from the upper portion 102 and the lower portion 103, or between at least one of the upper portion 102 and the lower portion 103 of the unit laminate 1. When the above is satisfied, the effect of securing energy density by reducing the overall thickness of batteries may not only be improved or maximized, but also safety during the penetration by a needle conductor may be substantially secured.

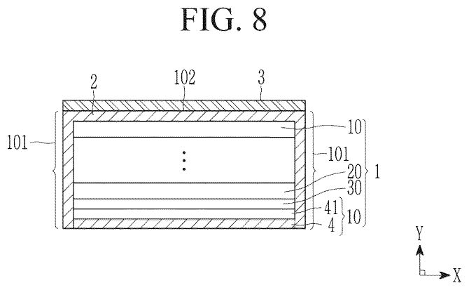

For example, the unit laminate 1, as shown in FIG. 8, may include the positive electrode substrate 4 located at the outermost in the stacking direction (Y); and the positive electrode 10 including the positive electrode active material layer 41 on the positive electrode substrate 4.

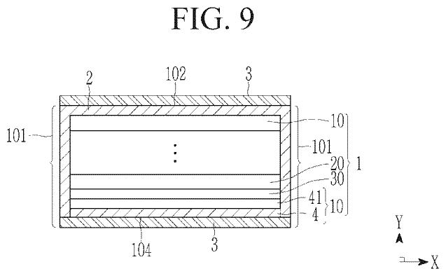

In some example embodiments, the uncoated region 2 may include the side portion 101 wrapping a side of the unit laminate 1; and the upper portion 102 wrapping the positive electrode 10, an upper electrode, in the stacking direction (Y) of the unit laminate 1; and the safety functional layer 3 as shown in FIGS. 8 and 9, may be disposed on the outermost surface of the upper portion 102 such as, e.g., opposite to the other surface of the upper portion 102 of the uncoated region 2 which is in contact with the positive electrode 10, an upper electrode.

In some example embodiments, the safety functional layer 3, as shown in FIG. 9, may be disposed on the uncoated region, one outermost surface 104 opposite to the other outermost surface of the positive electrode substrate 4 which is coated with the positive electrode active material layer in the positive electrode 10, a lower electrode, in the stacking direction (Y) of the unit laminate 1. When the above is satisfied, safety may be further improved.

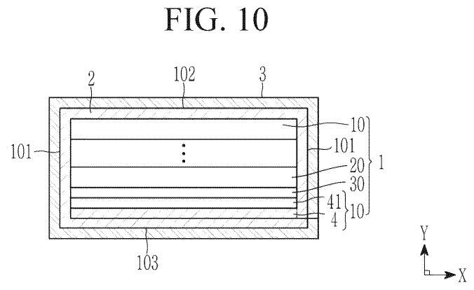

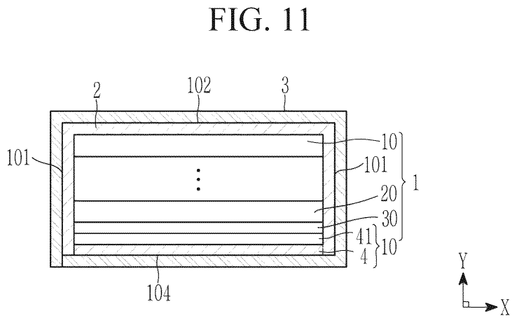

In some example embodiments, the safety functional layer 3, as shown in FIG. 10, may be disposed on the outermost surfaces of the side portion 101, the upper portion 102, and the lower portion 103 in the uncoated region. For example, the safety functional layer 3, as shown in FIG. 11, may be disposed on the outermost surface of the side portion 101 and the upper portion 102 of the uncoated region 2 and/or on the surface 104 opposite to the surface of the positive electrode substrate 4 where the positive electrode active material layer is coated in the positive electrode 10 at the outermost, a lower electrode in the stacking direction (Y) of the unit laminate 1. The safety improvement effect may be further increased.

The unit laminate 1 may include the positive electrode 10 and the negative electrode 20, for example, the positive electrode, the negative electrode, and an electrolyte. For example, the unit laminate may include the positive electrode 10, the negative electrode 20, a separator 30 disposed between the positive electrode 10 and the negative electrode 20, and an electrolyte solution.

According to some example embodiments, the unit laminate 1 may include the positive electrode 10 and the negative electrode 20 as a minimum or single unit and in addition to the separator 30 and the electrolyte solution, additionally include another positive electrode 10 and another negative electrode 20, which may be stacked. In FIGS. 6 to 11, a stacking form of the minimum or single unit of the electrode assembly 40 is illustrated, but other stacking forms may include all forms in the related technical field. In FIGS. 6 to 11, the stacked electrode assembly 40 is described as an example, but the present disclosure is not limited thereto and may include, e.g., a stacking type, a winding type (jelly-roll type), a stack and folding type, a Z-folding type, and the like all, wherein specific forms thereof are omitted.

For example, when the electrode assembly 40 is a winding type (jelly-roll type) electrode assembly, the unit laminate 1 may be obtained by stacking four (4) layers of a positive electrode, a separator, a negative electrode, and a separator as a minimum or single unit, and by rolling the four (4) layers with the positive electrode on the outside into a jelly-roll type electrode assembly.

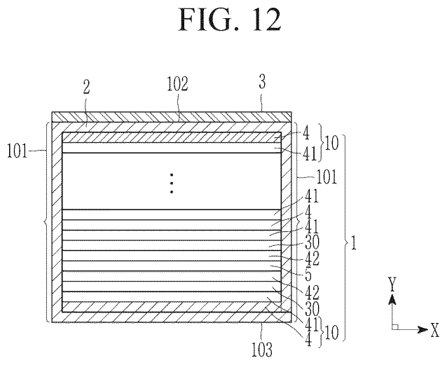

In some example embodiments, when the electrode assembly 40 is the stacked electrode assembly, as shown in FIG. 12, the unit laminate 1 may be obtained by stacking the positive electrode substrate 4; the positive electrode active material layer 41; the separator 30; the negative electrode active material layer 42; the negative electrode substrate 5; the negative electrode active material layer 42; the separator 30; the positive electrode active material layer 41; the positive electrode substrate 4; and the positive electrode active material layer 41; wherein the positive electrode substrate 4 may be exposed on the lower portion and the upper portion in the stacking direction (Y).

### Positive Electrode

The positive electrode may include a positive electrode current collector, and a positive electrode active material layer on the positive electrode current collector, and the positive electrode active material layer may include a positive electrode active material, a binder, a conductive material, or a combination thereof.

The positive electrode active material may include a compound (lithiated intercalation compound) capable of intercalating and deintercalating lithium. For example, at least one of a composite oxide of lithium and a metal such as or including at least one of cobalt, manganese, nickel, and combinations thereof may be used.

The composite oxide may be or include a lithium transition metal composite oxide, and examples thereof may include lithium nickel-based oxide, lithium cobalt-based oxide, lithium manganese-based oxide, lithium iron phosphate-based compound, cobalt-free lithium nickel-manganese-based oxide, and overlithiated layered oxide, or a combination thereof.

For example, the positive electrode active material may be or include a high-nickel positive electrode active material having a nickel content that is greater than or equal to about 80 mol % based on 100 mol % of a metal excluding lithium in the lithium transition metal composite oxide. A nickel content in the high-nickel positive electrode active material may be greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium. The high-nickel positive electrode active material can achieve high capacity, and can be applicable to high-capacity, high-density rechargeable lithium batteries.

As another example, a compound represented by any one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}Dα (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8)

In the above chemical formulas, A is or includes at least one of Ni, Co, Mn, or a combination thereof; X is or includes at least one of Al, Ni, Co, Mn, Cr, Fe, Mg, Sr, V, a rare earth element or a combination thereof; D is or includes at least one of O, F, S, P, or a combination thereof; G is or includes at least one of Al, Cr, Mn, Fe, Mg, La, Ce, Sr, V, or a combination thereof; Q is or includes at least one of Ti, Mo, Mn, or a combination thereof; Z is or includes at least one of Cr, V, Fe, Sc, Y, or a combination thereof; and L¹ is or includes at least one of Mn, Al or a combination thereof.

In the positive electrode active material layer, the binder is configured to attach positive electrode active material particles to each other, and to attach positive electrode active material to adjacent layers. Examples of binders may include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but are not limited thereto.

In the positive electrode active material layer, the conductive material is included to provide electrode conductivity, and any electrically conductive material may be included as a conductive material unless the electrically conductive material causes a chemical change in the battery. Examples of the conductive material may include a carbon-based material such as at least one of natural graphite, artificial graphite, carbon black, acetylene black, ketjen black, a carbon fiber, a carbon nanofiber, a carbon nanotube, and the like; a metal-based material of a metal powder or a metal fiber including at least one of copper, nickel, aluminum, silver, and the like; a conductive polymer such as a polyphenylene derivative; or a mixture thereof.

In the positive electrode active material layer, each content of the binder and the conductive material may be in a range of about 0.5 wt % to about 5 wt % based on 100 wt % of the positive electrode active material layer.

### Negative Electrode

The negative electrode may include a current collector; and a negative electrode active material layer on the current collector, and the negative electrode active material layer may include a negative electrode active material and may further include a binder, a conductive material, or a combination thereof.

At this time, when the negative electrode corresponds to the aforementioned electrode, the aforementioned electrode current collector may be a negative electrode current collector, and the aforementioned electrode active material layer may be a negative electrode active material layer.

The material that reversibly intercalates/deintercalates lithium ions may include, for example crystalline carbon, amorphous carbon, or a combination thereof as a carbon-based negative electrode active material. The crystalline carbon may be irregular, or sheet, flake, spherical, or fiber shaped natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOₓ (0<x≤2), a Si-Q alloy (wherein Q is or includes at least one of an alkali metal, an alkaline-earth metal, a Group 13 element, a Group 14 element (excluding Si), a Group 15 element, a Group 16 element, a transition metal, a rare earth element, and a combination thereof, for example at least one of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof), or a combination thereof. The Sn-based negative electrode active material may be or include at least one of Sn, SnO₂, a Sn alloy, or a combination thereof.

The silicon-carbon composite may be a composite of silicon and amorphous carbon. An average particle diameter (D₅₀) of the silicon-carbon composite particles may be in a range of, for example, about 0.5 μm to about 20 μm. According to some example embodiments, the silicon-carbon composite may be in the form of silicon particles, and amorphous carbon coated on the surface of the silicon particles. For example, the silicon-carbon composite may include a secondary particle (core) in which silicon primary particles are assembled, and an amorphous carbon coating layer (shell) on the surface of the secondary particle. The amorphous carbon may also be present between the silicon primary particles, for example, the silicon primary particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer on the surface of the core. The crystalline carbon may be or include artificial graphite, natural graphite, or a combination thereof. The amorphous carbon may include at least one of soft carbon or hard carbon, a mesophase pitch carbonized product, and calcined coke.

When the silicon-carbon composite includes silicon and amorphous carbon, a silicon content may be in a range of about 10 wt % to about 50 wt %, and a content of amorphous carbon may be in a range of about 50 wt % to about 90 wt % based on 100 wt % of the silicon-carbon composite. In addition, when the composite includes silicon, amorphous carbon, and crystalline carbon, a silicon content may be in a range of about 10 wt % to about 50 wt %, a content of crystalline carbon may be in a range of about 10 wt % to about 70 wt %, and a content of amorphous carbon may be in a range of about 20 wt % to about 40 wt % based on 100 wt % of the silicon-carbon composite.

Additionally, a thickness of the amorphous carbon coating layer may be in a range of about 5 nm to about 100 nm. An average particle diameter (D₅₀) of the silicon particles (primary particles) may be in a range of about 10 nm to about 1 μm, or in a range of about 10 nm to about 200 nm. The silicon particles may be in the form of silicon alone, in the form of a silicon alloy, or in an oxidized form. The oxidized form of silicon may be represented by SiOₓ (0<x≤2). For example, the atomic content ratio of Si:O, which indicates a degree of oxidation, may be in a range of about 99:1 to about 33:67. As included herein, when a definition is not otherwise provided, an average particle diameter (D₅₀) indicates a particle where an accumulated volume is about 50 volume % in a particle distribution.

The Si-based negative electrode active material or Sn-based negative electrode active material may be mixed with the carbon-based negative electrode active material. When the Si-based negative electrode active material or Sn-based negative electrode active material and the carbon-based negative electrode active material are mixed, the mixing ratio may be a weight ratio in a range of about 1:99 to about 90:10.

The binder is configured to adhere the negative electrode active material particles to each other, and to adhere the negative electrode active material to the current collector. The binder may be or include at least one of a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include at least one of a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When an aqueous binder is included as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed. The alkali metal may be or include at least one of Na, K, or Li.

The dry binder may be or include a polymer material capable of becoming fiber, and may be or include, for example, at least one of polytetrafluoroethylene, polyvinylidene fluoride, a polyvinylidene fluoride-hexafluoropropylene copolymer, polyethylene oxide, or a combination thereof.

The conductive material is included to provide electrode conductivity, and any electrically conductive material may be included as a conductive material unless the electrically conductive material causes a chemical change in the battery. Examples of the conductive material include a carbon-based material such as at least one of natural graphite, artificial graphite, carbon black, acetylene black, ketjen black, a carbon fiber, a carbon nanofiber, a carbon nanotube, and the like; a metal-based material of a metal powder or a metal fiber including at least one of copper, nickel, aluminum silver, and the like; a conductive polymer such as a polyphenylene derivative; or a mixture thereof.

A content of the negative electrode active material may be in a range of about 95 wt % to about 99.5 wt % based on 100 wt % of the negative electrode active material layer, and a content of the binder may be in a range of about 0.5 wt % to about 5 wt % based on 100 wt % of the negative electrode active material layer. For example, the negative electrode active material layer may include about 90 wt % to about 99 wt % of the negative electrode active material, about 0.5 wt % to about 5 wt % of the binder, and about 0.5 wt % to about 5 wt % of the conductive material.

The negative electrode current collector may include, for example, at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil, sheet, or foam. A thickness of the negative electrode current collector may be in a range of, for example, about 1 μm to about 20 μm, about 5 μm to about 15 μm, or about 7 μm to about 10 μm.

### Electrolyte

For example, the electrolyte for a rechargeable lithium battery may be or include an electrolyte solution, which may include a non-aqueous organic solvent and a lithium salt.

The non-aqueous organic solvent is configured as a medium for transmitting ions taking part in the electrochemical reaction of a battery. The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include at least one of ethanol, isopropyl alcohol, and the like and the aprotic solvent may include at least one of nitriles such as R—CN (wherein R is a C2 to C20 linear, branched, or cyclic hydrocarbon group, a double bond, an aromatic ring, or an ether group, and the like); amides such as dimethylformamide; dioxolanes such as 1,3-dioxolane, 1,4-dioxolane, and the like; sulfolanes, and the like.

The non-aqueous organic solvent can be included alone or in a mixture of two or more types of solvent, and when two or more types or solvent are included in a mixture, a mixing ratio can be adjusted as desired according to the desired battery performance, which is known to those with knowledge in the art.

When using a carbonate-based solvent, a cyclic carbonate and a chain carbonate may be mixed, and the cyclic carbonate and the chain carbonate may be mixed in a volume ratio in a range of about 1:1 to about 1:9.

The non-aqueous organic solvent may further include an aromatic hydrocarbon-based organic solvent. For example, a carbonate-based solvent and an aromatic hydrocarbon-based organic solvent may be mixed and included in a volume ratio in a range of about 1:1 to about 30:1.

The electrolyte solution may further include at least one of vinylethyl carbonate, vinylene carbonate, or an ethylene carbonate-based compound to improve battery cycle-life.

Examples of the ethylene carbonate-based compound may include at least one of fluoroethylene carbonate, difluoroethylene carbonate, chloroethylene carbonate, dichloroethylene carbonate, bromoethylene carbonate, dibromoethylene carbonate, nitroethylene carbonate, and cyanoethylene carbonate.

The lithium salt dissolved in the organic solvent is configured to supply lithium ions in a battery, to enable a basic operation of a rechargeable lithium battery, and to improve transportation of the lithium ions between positive and negative electrodes. Examples of the lithium salt may include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl) imide; LiFSI), LiC₄F₉SO₃, LiN(CₓF₂ₓ₊₁SO₂) (C_{y}F_{2y+1}SO₂) (wherein x and y are integers in a range of 1 to 20), lithium trifluoromethane sulfonate, lithium tetrafluoroethane sulfonate, lithium difluorobis(oxalato) phosphate (LiDFOB), and lithium bis(oxalato) borate (LiBOB).

A concentration of lithium salt may be within the range of about 0.1 M to about 2.0 M. When the concentration of lithium salt is within the above range, the electrolyte solution has appropriate or desired ionic conductivity and viscosity, and thus desired or improved performance can be achieved and lithium ions can move effectively.

### Separator

Depending on the type of the rechargeable lithium battery, a separator may be present between the positive electrode and the negative electrode. The separator may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof, on one surface, or on both surfaces, of the porous substrate.

The porous substrate may be or include a polymer film formed of or including any one polymer such as at least one of polyolefin such as polyethylene and polypropylene, polyester such as at least one of polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The porous substrate may have a thickness in a range of about 1 μm to about 40 μm, for example, about 1 μm to about 30 μm, about 1 μm to about 20 μm, about 5 μm to about 15 μm, or about 10 μm to about 15 μm.

The organic material may include a (meth)acrylic copolymer including a first structural unit derived from (meth)acrylamide, and a second structural unit including at least one of a structural unit derived from (meth)acrylic acid or (meth)acrylate, and a structural unit derived from (meth)acrylamidosulfonic acid or a salt thereof.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiOs, Mg(OH)₂, boehmite, and a combination thereof, but is not limited thereto. An average particle diameter (D₅₀) of the inorganic particles may be in a range of about 1 nm to about 2000 nm, for example, about 100 nm to about 1000 nm, or about 100 nm to about 700 nm.

The organic material and the inorganic material may be mixed in one coating layer, or a coating layer including an organic material and a coating layer including an inorganic material may be stacked.

The thickness of the coating layer may be in a range of about 0.5 μm to about 20 μm, for example, about 1 μm to about 10 μm, or about 1 μm to about 5 μm.

### Method of Preparing Electrode Assembly

In some example embodiments, a method of preparing an electrode assembly includes preparing a unit laminate including a positive electrode and a negative electrode, assembling the uncoated region to surround at least a portion of the above unit laminate, and forming a safety functional layer on at least a portion of the uncoated region, wherein the safety functional layer includes an extinguishing capsule and the extinguishing capsule includes a core including a halogen compound; and a shell surrounding the core and including a polymer compound.

The above description relates to a method for preparing the electrode assembly according to some example embodiments, and hereinafter, descriptions that overlap the above description regarding the positive electrode are omitted, and the method of preparing the electrode assembly according to some example embodiments is described in detail.

For example, a unit laminate including a positive electrode and a negative electrode is prepared. The unit laminate may further include a separator and an electrolyte solution in addition to the positive electrode and the negative electrode described above, to which the aforementioned description may be equally applied.

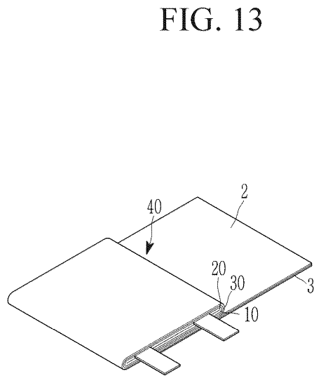

Subsequently, the uncoated region is assembled therewith to wrap at least a portion of the unit laminate. FIG. 13 schematically shows a process of preparing the electrode assembly according to some example embodiments, and the uncoated region 2, where an active material layer and the like are not formed, as shown in FIG. 5, is rolled to wrap at least a portion of the unit laminate 1 to cover the unit laminate. The uncoated region 2 may be or include, for example, a positive electrode substrate (positive electrode current collector). Accordingly, the uncoated region may be or include an Al substrate, an SUS substrate, or a combination thereof.

On at least a portion of the uncoated region, a safety functional layer is formed. The safety functional layer is formed by mixing an extinguishing capsule in a solvent to prepare a slurry for a safety functional layer, applying the slurry for a safety functional layer on at least a portion of the uncoated region, and drying the slurry. Herein, the applying method may be performed by, e.g., adopting coating, and as for coating and drying methods, conventional methods of relevant technologies may be applied without limitation. The safety functional layer may be formed on the uncoated region before assembling the uncoated region with the unit laminate to wrap the unit laminate, or after assembling the uncoated region to wrap the unit laminate.

Herein, the above description about the safety functional layer and the extinguishing capsule is equally applied here and is not repeated in detail.

### Rechargeable Lithium Battery

In some example embodiments, a rechargeable lithium battery includes the aforementioned electrode assembly; and a battery case accommodating the electrode assembly.

Rechargeable lithium batteries can be classified into cylindrical, square, pouch, and coin types depending on their shape, with a pouch type being a representative example.

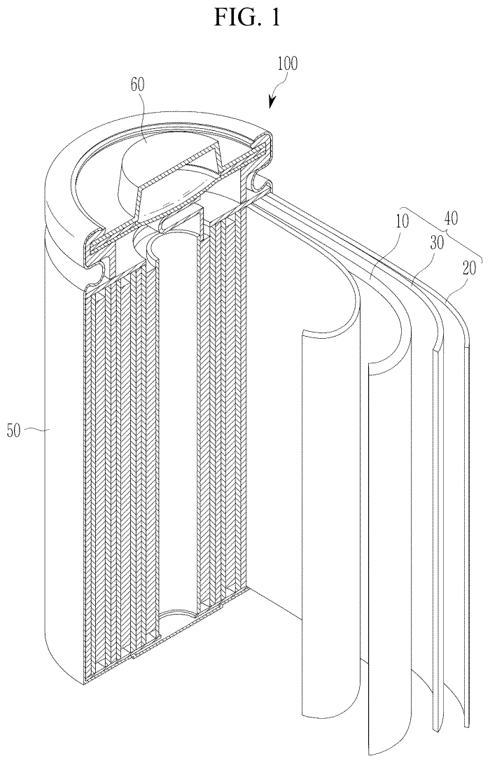

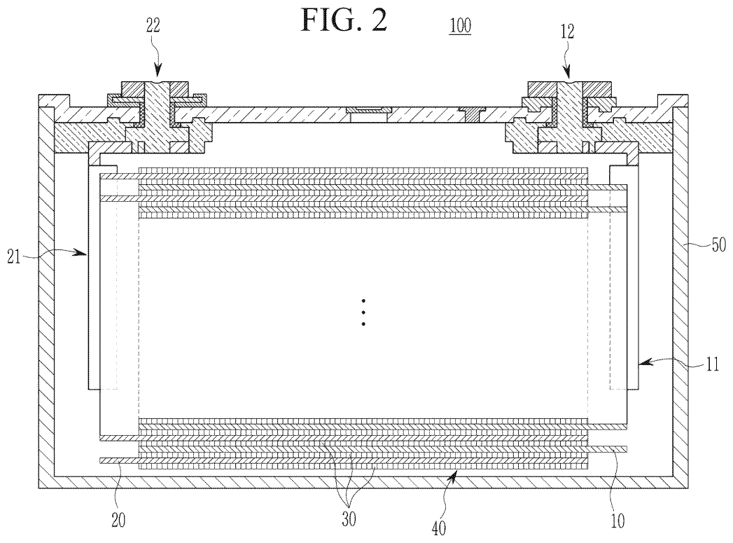

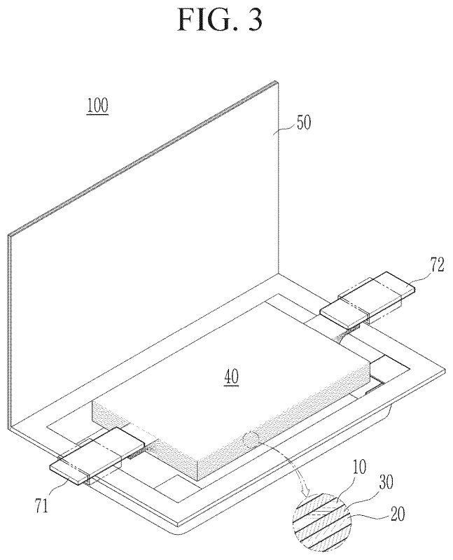

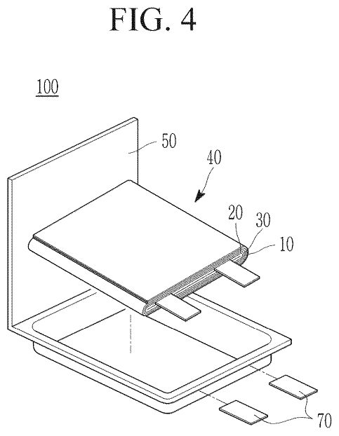

FIGS. 1 to 4 are perspective views illustrating a rechargeable lithium battery according to one embodiment. FIG. 1 shows a cylindrical battery, FIG. 2 shows a prismatic battery, and FIGS. 3 and 4 show a pouch battery. Referring to FIGS. 1 to 4, the rechargeable lithium battery 100 may include an electrode assembly 40 with a separator 30 interposed between a positive electrode 10 and a negative electrode 20, and a battery case 50 in which the electrode assembly 40 is housed therein. The positive electrode 10, negative electrode 20, and separator 30 may be impregnated with an electrolyte solution (not shown). The rechargeable lithium battery 100 may include a sealing member 60 that seals a battery case 50 as shown in FIG. 1. Additionally, in FIG. 2, the rechargeable lithium battery 100 may include a positive electrode lead tab 11, a positive electrode terminal 12, a negative electrode lead tab 21, and a negative electrode terminal 22. As shown in FIGS. 3 and 4, the rechargeable lithium battery 100 includes an electrode tab 70 illustrated in FIG. 4, a positive electrode tab 71 and a negative electrode tab 72 illustrated in FIG. 3, the electrode tabs 70/71/72 forming an electrical path for inducing the current formed in the electrode assembly 40 to the outside of the battery 100.

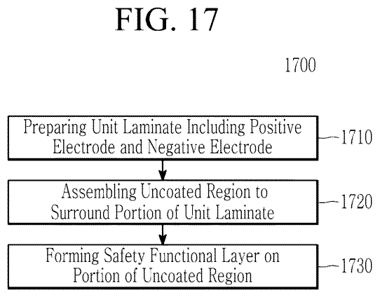

FIG. 17 is a flow chart illustrating a method for preparing an electrode assembly, according to an example embodiment. In FIG. 17, the method 1700 includes operation 1710, which includes preparing a unit laminate including a positive electrode and a negative electrode. Operation 1720 includes assembling the uncoated region to surround at least a portion of the unit laminate. Operation 1730 includes forming a safety functional layer on at least a portion of the uncoated region. In examples, the safety functional layer includes an extinguishing capsule, the extinguishing capsule includes a core including a halogen compound, and a shell surrounding the core and including a polymer compound. Examples and comparative examples of the present disclosure are described below. However, the following examples are only examples of the present disclosure, and the present disclosure is not limited to the following examples.

### Example 1

98.15 wt % of a positive electrode active material (LiCoO₂), 0.8 wt % of carbon black, and 1.05 wt % of a PVDF binder were mixed in an NMP solvent to prepare a positive electrode slurry, and this positive electrode slurry was coated on an aluminum foil current collector, and then dried and pressed to prepare a positive electrode.

A negative electrode slurry was prepared by mixing 97.5 wt % of a graphite negative electrode active material, 1.5 wt % of carboxymethyl cellulose, and 1 wt % of a styrene butadiene rubber in a water solvent. The negative electrode slurry was coated on a copper foil current collector, and then dried and pressed to prepare a negative electrode.

A polytetrafluoroethylene separator and an electrolyte solution, which was prepared by mixing ethylene carbonate and dimethyl carbonate in a volume ratio of 3:7 in a solvent and dissolving 1 M LiPF₆ therein, were used to prepare a unit laminate like a unit laminate 1 shown in FIG. 12 in a conventional method, which was assembled with an uncoated region of the positive electrode foil current collector to wrap the unit laminate.

Subsequently, an extinguishing capsule including a core of 1,1,1,2,2,3,4,5,5,5-decafluoro-3-methoxy-4-(trifluoromethyl)-pentane (DMTP) and a shell of polymethyl methacrylate ((PMMA), a weight average molecular weight (Mw): 300,000 g/mol)) and having an average particle diameter (D₅₀) of 0.3 μm was prepared. Herein, the extinguishing capsule had a core and shell ratio of the core of 50 wt % and the shell of 50 wt %, wherein the core had an average diameter of 0.28 μm, and the shell had a thickness of 0.01 μm.

Subsequently, the extinguishing capsule was mixed with a styrene butadiene rubber (SBR) in a distilled water solvent to prepare a slurry for forming a safety functional layer. The slurry for a safety functional layer was coated only on the outmost surface of an upper portion of the uncoated region wrapping the positive electrode, an upper electrode, in a stacking direction (Y) of the unit laminate and then, dried at 80° C. in a vacuum-drier under a vacuum atmosphere to obtain an electrode assembly having a safety functional layer with a thickness 20 μm to 35 μm, which had a shape shown in FIG. 6.

This electrode assembly was housed in a battery case, and then sealed to prepare a rechargeable lithium battery cell.

### Example 2

An electrode assembly and a rechargeable lithium battery cell were prepared substantially in the same manner as in Example 1, with a difference that the electrode assembly was obtained to have a shape shown in FIG. 7 by forming the safety functional layer between the upper portion wrapping the positive electrode, an upper electrode in the stacking direction (Y) of the unit laminate, and the unit laminate.

### Comparative Example 1

An electrode assembly and a rechargeable lithium battery cell were prepared substantially in the same manner as in Example 1, with a difference that an insulation layer instead of the safety functional layer was formed by using a slurry prepared by mixing 50 wt % of boehmite and 50 wt % of a styrene butadiene rubber (SBR) in a distilled water solvent.

### Comparative Example 2

An electrode assembly and a rechargeable lithium battery cell were prepared substantially in the same manner as in Example 1, with a difference that the electrode assembly was prepared by not forming the safety functional layer.

### Evaluation Example 1: Penetration Evaluation of Needle Conductor

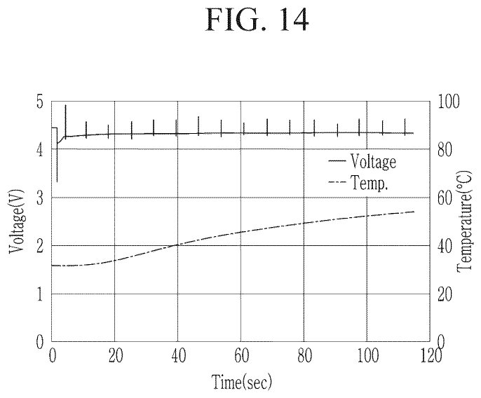

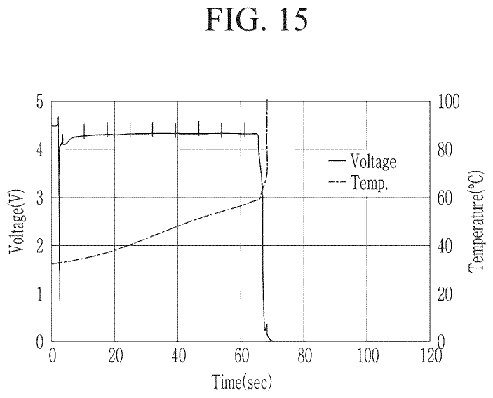

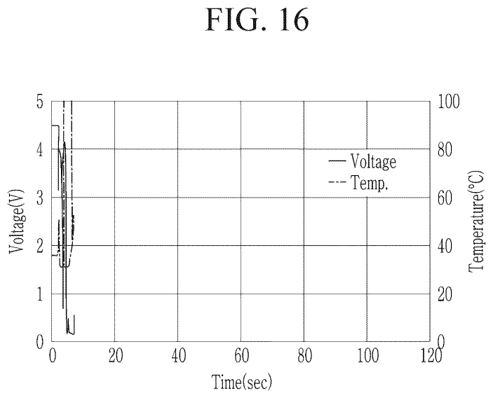

The rechargeable lithium battery cells according to Example 1 and Comparative Examples 1 and 2 in a full-charge state (SOC 100%) were evaluated with respect to safety during penetration of a needle conductor by penetrating the cells from the upper surface to the lower surface with a nail, the needle conductor, in the stacking direction (Y) of the electrode assembly. In the penetration evaluation, the experiment results of temperature and voltage changes over time of Example 1 and Comparative Examples 1 and 2 are respectively shown in FIGS. 14 to 16.

Referring to FIGS. 14 to 16, Example 1 exhibited a gradual temperature increase until 115 seconds but no voltage change, but Comparative Example 1 exhibited a rapid temperature increase at 58° C. in just 66 seconds and a voltage decrease to 0 V, and Comparative Example 2 exhibited a voltage change to 0 V at 50° C. in just 24 seconds, which confirmed that an internal short circuit occurred.

Accordingly, the rechargeable lithium battery cell of Example 1 exhibited desired or improved safety, compared to the rechargeable lithium battery cells of Comparative Examples 1 and 2.

### Evaluation Example 2: High Temperature Safety Evaluation

In order to evaluate safety at a high temperature, each of the electrode assemblies according to Examples 1 and 2 and Comparative Examples 1 and 2 was allowed to stand at 150° C. for 1 hour to check whether or not an internal short circuit occurred, and the results are shown in Table 1 below.

TABLE 1

| | Whether an internal |
|---|---|
| | short circuit occurs |
| Example 1 | Not occur |
| Example 2 | Not occur |
| Comparative Example 1 | Occur |
| Comparative Example 2 | Occur |

Referring to the results of Table 1, Examples 1 and 2, compared to Comparative Examples 1 and 2, exhibited desired or improved safety at a high temperature.

### Evaluation Example 3: Charging and Discharging Characteristics

The rechargeable lithium battery cells according to Example 1 and Comparative Examples 1 and 2 were charged to an upper limit voltage of 4.5 V at a constant current of 0.2 C and to 0.02 C at the constant voltage, and then discharged to a cut-off voltage of 2.75 V at 0.2 C at 25° C. for initial charging and discharging. Table 2 below shows the initial charge capacity, initial discharge capacity, and a ratio of the latter to the former, which was calculated as efficiency.

TABLE 2

| | 0.2 C charge | 0.2 C discharge | Efficiency |
|---|---|---|---|
| | (mAh/g) | (mAh/g) | (%) |
| Example 1 | 188.2 | 187.4 | 99.6 |
| Comparative Example 1 | 187.8 | 187.1 | 99.6 |
| Comparative Example 2 | 187.9 | 186.9 | 99.5 |

Referring to the results of Table 1, Example 1, compared to Comparative Examples 1 and 2, exhibited similar capacity and efficiency characteristics and in addition, one or more desired or improved characteristics out of the initial charging capacity, the initial discharging capacity, and the efficiency. Accordingly, Example 1 exhibited safety effects without deteriorating cell performance.

While this disclosure has been described in connection with what is presently considered to be practical example embodiments, it is to be understood that the disclosure is not limited to the disclosed example embodiments. On the contrary, the disclosure is intended to cover various modifications and equivalent arrangements included within the spirit and scope of the appended claims.

### DESCRIPTION OF SYMBOLS

| | |
|---|---|
| 1: unit laminate | 2: uncoated region |
| 3: safety function layer | |
| 4: positive electrode substrate located at | |
| the outermost layer | |
| 5: negative electrode substrate | |
| 41: positive electrode active material layer | |
| 42: negative electrode active material layer | |
| 101: side portion | |
| 102: upper portion | 103: lower portion |
| 104: surface opposite to the surface | |
| on which the positive electrode active | |
| material layer is coated among the | |
| positive electrode substrate | |
| 100: rechargeable lithium battery | 10: positive electrode |
| 11: positive electrode lead tab | 12: positive electrode terminal |
| 20: negative electrode | 21: negative electrode lead tab |
| 22: negative electrode terminal | 30: separator |
| 40: electrode assembly | 50: battery case |
| 60: sealing member | 70: electrode tab |
| 71: positive electrode tab | 72: negative electrode tab |

What is claimed is:

1. An electrode assembly, comprising:
a unit laminate including a positive electrode and a negative electrode;
an uncoated region covering at least a portion of the unit laminate; and
a safety functional layer on at least a portion of the uncoated region;
wherein the safety functional layer comprises an extinguishing capsule, and
the extinguishing capsule comprises:
a core including a substituted or unsubstituted halogen compound; and
a shell surrounding the core and including a polymer compound.

2. The electrode assembly as claimed in claim 1, wherein the substituted or unsubstituted halogen compound comprises at least one of a substituted or unsubstituted halogenated alkyl, a substituted or unsubstituted halogenated cycloalkyl, a substituted or unsubstituted halogenated alkene, a substituted or unsubstituted halogenated alkyne, a substituted or unsubstituted halogenated acyl, and a substituted or unsubstituted halogenated ketone.

3. The electrode assembly as claimed in claim 1, wherein the substituted or unsubstituted halogen compound comprises at least one of a substituted or unsubstituted C1 to C10 halogenated alkyl, a substituted or unsubstituted C3 to C6 halogenated cycloalkyl, a substituted or unsubstituted C2 to C6 halogenated alkene, a substituted or unsubstituted C2 to C6 halogenated alkyne, a substituted or unsubstituted C1 to C10 halogenated acyl, and a substituted or unsubstituted C1 to C10 halogenated ketone.

4. The electrode assembly as claimed in claim 1, wherein the halogen compound comprises about 1 to 15 halogen elements in the compound.

5. The electrode assembly as claimed in claim 1, wherein at least one hydrogen of the halogen compound is substituted with a substituent comprising at least one of a hydroxy group, a C1 to C10 alkoxy group, a C1 to C10 alkyl group, a C2 to C10 alkenyl group, a C2 to C10 alkynyl group, a C6 to C20 aryl group, and a C3 to C10 cycloalkyl group.

6. The electrode assembly as claimed in claim 1, wherein the substituted or unsubstituted halogen compound comprises at least one of monofluoromethane, difluoromethane, trifluoromethane, tetrafluoromethane, trifluorobromomethane, difluorochloromethane, trifluoroiodomethane, pentafluoroethane, pentachloroethane, pentabromoethane, tetrafluorodibromoethane, difluorochlorobromoethane, octafluorodichloroethane, chlorotetrafluoroethane, heptafluoropropane, heptachloropropane, heptabromopropane, hexafluoropropane, hexachloropropane, hexabromopropane, decafluorobutane, dodecafluoro-2-methylpentan-3-one, and decafluoromethoxytrifluoromethylpentane.

7. The electrode assembly as claimed in claim 1, wherein the halogen compound is included in an amount in a range of about 10 wt % to about 90 wt % based on 100 wt % of the extinguishing capsule.

8. The electrode assembly as claimed in claim 1, wherein the polymer compound comprises an acrylate-based resin.

9. The electrode assembly as claimed in claim 1, wherein the polymer compound comprises at least one of polymethyl acrylate, polymethyl methacrylate, polyethyl acrylate, polyethyl methacrylate, poly(n-propyl acrylate), poly(n-propyl methacrylate), polyisopropyl acrylate, polyisopropyl methacrylate, polybutyl acrylate, polybutyl methacrylate, polyisobutyl acrylate, polyisobutyl methacrylate, polyethylhexyl acrylate, and polyethylhexyl methacrylate.

10. The electrode assembly as claimed in claim 1, wherein a weight average molecular weight of the polymer compound is in a range of about 200,000 g/mol to about 400,000 g/mol.

11. The electrode assembly as claimed in claim 1, wherein the polymer compound is included in an amount in a range of about 10 wt % to about 90 wt % based on 100 wt % of the extinguishing capsule.

12. The electrode assembly as claimed in claim 1, wherein an average particle diameter of the extinguishing capsule is in a range of about 0.1 μm to about 3 μm.

13. The electrode assembly as claimed in claim 1, wherein a thickness of the safety functional layer is in a range of about 10 μm to about 50 μm.

14. The electrode assembly as claimed in claim 1, wherein at least one of:
the safety functional layer is located on at least a portion between the unit laminate and the uncoated region, and
the safety functional layer is located on at least a portion of the outermost surface of the uncoated region.

15. The electrode assembly as claimed in claim 14, wherein the uncoated region comprises at least one of:
side portions surrounding both sides of the unit laminate;
the upper portion covering an upper electrode of the unit laminate; and
a lower portion covering a lower electrode of the unit laminate;
wherein the safety function layer is located on at least one outermost surface of the side portions, the upper portion, and the lower portion, or between at least one of the side portions, the upper portion, and the lower portion and the unit laminate.

16. The electrode assembly as claimed in claim 1, wherein the uncoated region comprises at least one of an aluminum substrate, and a SUS substrate.

17. The electrode assembly as claimed in claim 1, wherein:
the safety functional layer further comprises a binder, and
the binder comprises a styrene butadiene rubber.

18. A method for preparing an electrode assembly, the method comprising:
preparing a unit laminate including a positive electrode and a negative electrode,
assembling the uncoated region to surround at least a portion of the unit laminate, and
forming a safety functional layer on at least a portion of the uncoated region,
wherein the safety functional layer comprises an extinguishing capsule,
the extinguishing capsule comprises:
a core including a halogen compound; and
a shell surrounding the core and including a polymer compound.

19. A rechargeable lithium battery, comprising:
the electrode assembly as claimed in claim 1; and
a battery case accommodating the electrode assembly.
